(19) United States
(12) Patent Application Publication
(10) Pub. No.: US 2010/0306006 A1
(43) Pub. Date: Dec. 2, 2010

(54) Truthful Optimal Welfare Keyword Auctions

(76) Inventor: Elan Pavlov, Cambridge, MA (US)

Correspondence Address: SoCAL IP LAW GROUP LLP, 310 N. WESTLAKE BLVD. STE 120, WESTLAKE VILLAGE, CA, 91362, US

(21) Appl. No.: 12/475,243

(22) Filed: May 29, 2009

(51) Int. Cl. G06Q 10/00

(52) U.S. Cl. 705/8

(57) ABSTRACT

There is disclosed a method for auctioning a set of keywords. Bids may be received from a plurality of advertisers. Each bid may include a value of a click-through and a budget expressed as a maximum number of click-throughs. A flow graph may be created that relates the set of keywords to the bids received from the plurality of advertisers. A minimum cost flow solution may be determined for the flow graph, and the keywords may be allocated to the advertisers based on the minimum cost flow solution.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to keyword auctions, and particularly to keyword auctions for search engines.

2. Description of the Related Art

Internet search providers may auction search keywords, or search terms, to advertisers. In a typical keyword auction, advertisers bid on a single keyword or a set of keywords (sometimes with a budget constraint) and the search engine allocates each keyword to the highest bidder. The bids are typically made on a value per click-through, where a click-through occurs each time a search user clicks on an advertisement or sponsored search link. A click-through typically results in the search user being linked to a Web page or site provided by an advertiser. The price charged by the search engine is typically less than the amount bid. Commonly, the search engine charges the winner a “generalized second price” for an auction consisting only of one keyword, where the generalized second price may be the value bid by the next highest bidder.

Keyword auctions may be seen as a special case of a combinatorial auction and, since keywords are partial substitutes, the optimal allocation can not be made locally but must be chosen across the entire possibility of allocation with complex interdependencies between keywords.

### DESCRIPTION OF THE DRAWINGS

FIG. 1 is a flow chart of a process for auctioning a set of keywords.

FIG. 2 is a schematic diagram of a flow graph.

FIG. 3 is a schematic diagram of a flow graph.

FIG. 4 is a flow chart of a process for a auctioning a set of keywords.

FIG. 5 is a block diagram of a search system.

### DETAILED DESCRIPTION

Throughout this description, the embodiments and examples shown should be considered as exemplars, rather than limitations on the apparatus and methods disclosed or claimed.

Description of Processes

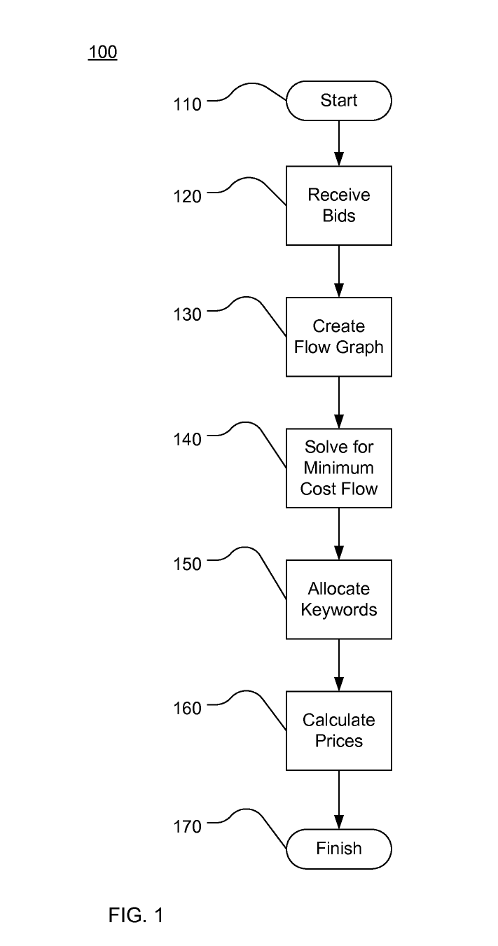

Referring now to FIG. 1, a flow chart of a process 100 for auctioning a set of keywords is shown. The process 100 is shown as having both a start 110 and a finish 170, but the process 100 may be cyclical in nature. For example, the process 100 could be repeated every time one or more new bids are received at 120.

Prior to, or coincident with, the start of the process 100 at 110, a set of keywords may be identified and made available to advertisers. The set of keywords may be complied by an on-line search provider, may be proposed by one or more advertisers, or may be identified by some other mechanism. At 120 bids may be received from a plurality of advertisers. Each bid may include a value for a click-through and a budget. The budget for each advertiser may be expressed as a maximum total number of click-throughs, or as a maximum total price for the click-throughs to be allocated to the advertiser.

At 130, a flow graph relating the set of keywords and the bids received from the plurality of advertisers may be created. A minimum cost flow solution for the flow graph may be computed at 140 using known methods for solving cost flow problems. For example, the methods described by Wayne (“A polynomial combinatorial algorithm for generalized minimum cost flow”, Mathematics of Operations Research, Vol. 27, No. 3, pp. 445-459, August 2002) may be used to determine the minimum cost flow solution.

At 150, the minimum cost flow solution may be used to allocate the keywords to the advertisers. The minimum cost flow solution may indicate that some portion of the occurrences of a specific keyword should be allocated to each of several advertisers.

At 160, the price of a click-through for each advertiser may be calculated using a known method for calculating keyword prices, such as the Generalized Second Price method, the VCG (Vickrey-Clarke-Groves) method, or by another pricing method.

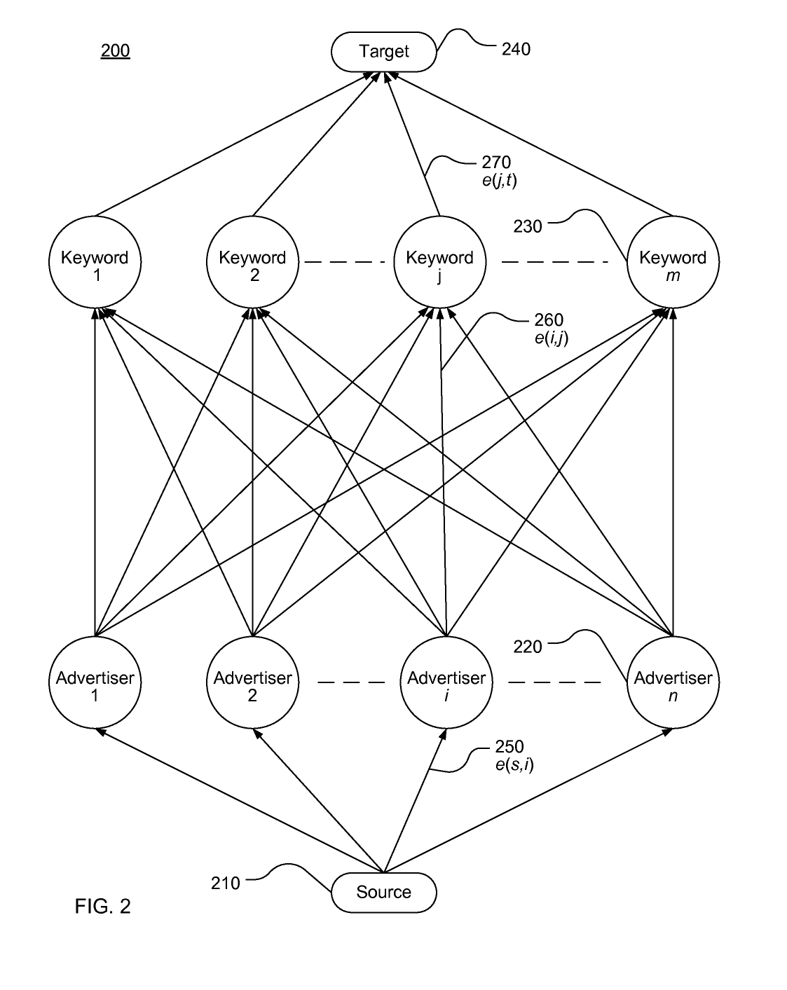

FIG. 2 shows an exemplary flow graph 200 that may be used to relate a set of m keywords to the bids received from a group of n advertisers. The graph may include a single source node 210, n advertiser nodes 220 representing the n advertisers, m keyword nodes 230 representing the m keywords, and a single target node 240. The source node 210 may be joined to the n advertiser nodes 220 by edges 250, where e(s,i) is the edge joining the source node to advertiser node i. The advertiser nodes 220 may be joined to the keyword nodes 230 by a total of n×m edges 260, where e(i,j) represents the edge joining advertiser node i to keyword node j. The keyword nodes 230 may be joined to the target node 240 by edges 270, where e(j,t) is the edge joining keyword node j to the target node.

A capacity, a cost, and a scaling factor may be defined for each edge in flow graph 200. Each edge e(s,i) may have a capacity of dᵢ, a unit cost of 0 and a scaling factor of 1, where dᵢ is the demand, expressed as a total number of click-throughs, included in the bid received from advertiser i. Each edge e(j,t) may have a capacity of aᵢ, a unit cost of 0 and a scaling factor of 1, where aᵢ is a anticipated number of appearances of keyword j. Each edge e(i,j) may have a capacity of ∞, a unit cost of −vᵢ, and a scaling factor of 1/pᵢⱼ, where vᵢ is the value included in the bid received from advertiser i and pᵢⱼ is a click-through probability for advertiser i and keyword j.

For each advertiser i and keyword j there may be a probability pᵢⱼ that a user searching for keyword j will click on the ad of advertiser i. Note that if pᵢⱼ was independent of j then all of the keywords would be the same and hence the problem would be reduced to a multi-unit auction. We may assume that all of the pᵢⱼ are known. In most work in the field, this is a commonly made assumption. This assumption is not unreasonable since a learning mechanism or a heuristic algorithm may be employed to analyze vast amounts of historical data held by search engines.

The minimum cost flow solution for the flow graph 200 may be a set of flows g(a,b), where g(a,b) is the flow along edge e(a,b). More specifically, g(s,i) is the flow along edge e(s,i) which is equal to the total number of click-throughs allocated to advertiser i. g(s,i) may be less than or equal to dᵢ, the demand, expressed as a total number of click-throughs, included in the bid received from advertiser i. Similarly, g(j,t) is the flow along edge e(j,t) which is equal to the total number of occurrences of keyword j that may be allocated to any advertiser. g(j,t) may be less than or equal to aⱼ, the anticipated number of appearances of keyword j.

The flow g(i,j) along edge e(i,j) is the number of click-throughs to advertiser i by people searching for keyword j. The number of appearances of keyword j that are allocated to advertiser i is given by g(i,j)/pᵢⱼ.

The minimum cost flow solution may commonly allocate occurrences of each keyword to more than one advertiser. For example, assuming the anticipated number of occurrences of keyword j is 100,000, advertiser i and advertiser k may each be allocated 50,000 occurrences. In this case, the occurrences of keyword j could simply be allocated to advertiser i and advertiser k alternately. In practice, the allocation of any keyword among a plurality of advertisers would not result in such convenient round numbers. Thus each keyword may be allocated among the advertisers according to a probability distribution. The probability that a given occurrence of keyword j is allocated to advertiser I may be given by g(i,j)/g(j,t)pᵢⱼ.

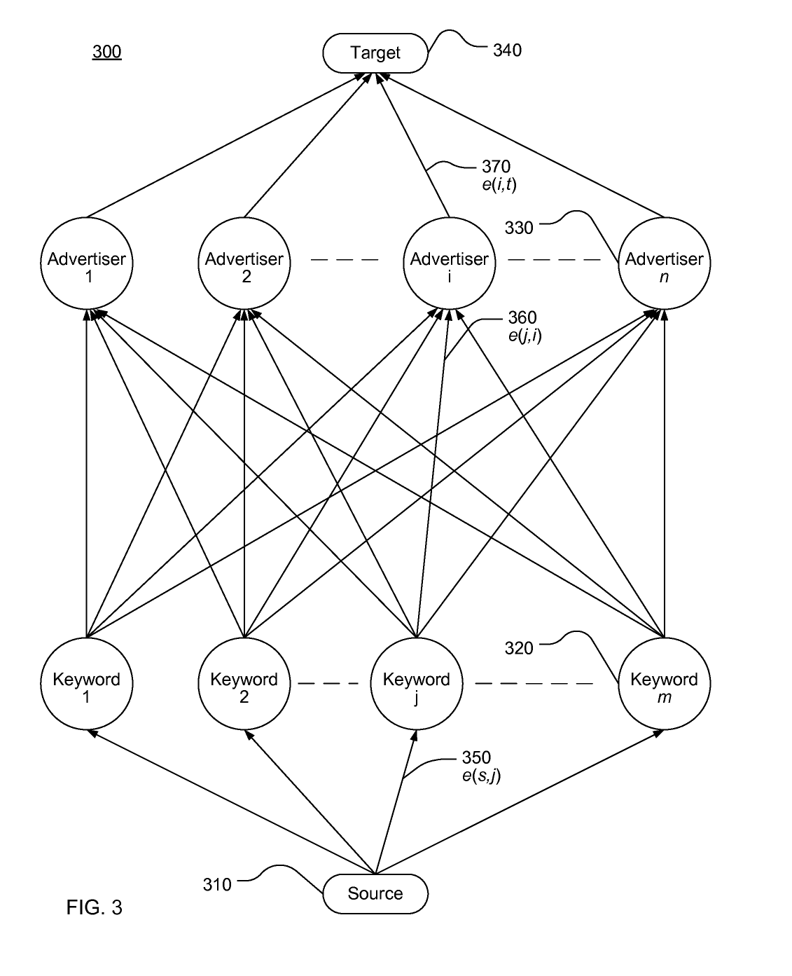

FIG. 3 shows another exemplary flow graph 300 that may be used to relate a set of m keywords to the bids received from a group of n advertisers. The graph may include a single source node 310, m keyword nodes 320 representing the m keywords, n advertiser nodes 330 representing the n advertisers, and a single target node 340. The source node 310 may be joined to the m keyword nodes 320 by edges 350, where e(s,j) is the edge joining the source node to keyword node j. The keyword nodes 320 may be joined to the advertiser nodes 330 by a total of n×m edges 360, where e(j,i) represents the edge joining keyword node j to advertiser node i. The advertiser nodes 330 may be joined to the target node 340 by edges 370, where e(i,t) is the edge joining advertiser node i to the target node.

A capacity, a cost, and a scaling factor may be defined for each edge in flow graph 300. Each edge e(s,j) may have a capacity of aᵢ, a unit cost of 0 and a scaling factor of 1, where aᵢ is a anticipated number of appearances of keyword j. Each edge e(i,t) may have a capacity of dᵢ, a unit cost of 0 and a scaling factor of 1, where dᵢ is the demand, expressed as a total number of click-throughs, included in the bid received from advertiser i. Each edge e(j,i) may have a capacity of ∞, a unit cost of −vᵢ, and a scaling factor of pᵢⱼ, where vᵢ is the value included in the bid received from advertiser i and pᵢⱼ is a click-through probability for advertiser i and keyword j.

The minimum cost flow solution for the flow graph 300 may be a set of flows h(a,b), where h(a,b) is the flow along edge e(a,b). More specifically, h(s,j) is the flow along edge e(s,j) which is equal to the total number of occurrences of keyword j that may be allocated to any advertiser. h(s,j) may be less than or equal to aⱼ, the anticipated number of appearances of keyword j. Similarly, h(i,t) is the flow along edge e(i,t) which is equal to the total number of click-throughs allocated to advertiser i. h(i,t) may be less than or equal to dᵢ, the demand, expressed as a total number of click-throughs, included in the bid received from advertiser i. The flow h(j,i) along edge e(j,j) is the number of occurrences of keyword j allocated to advertiser i. The number of click-throughs to advertiser i by people searching for keyword j is given by g(i,j)pᵢⱼ.

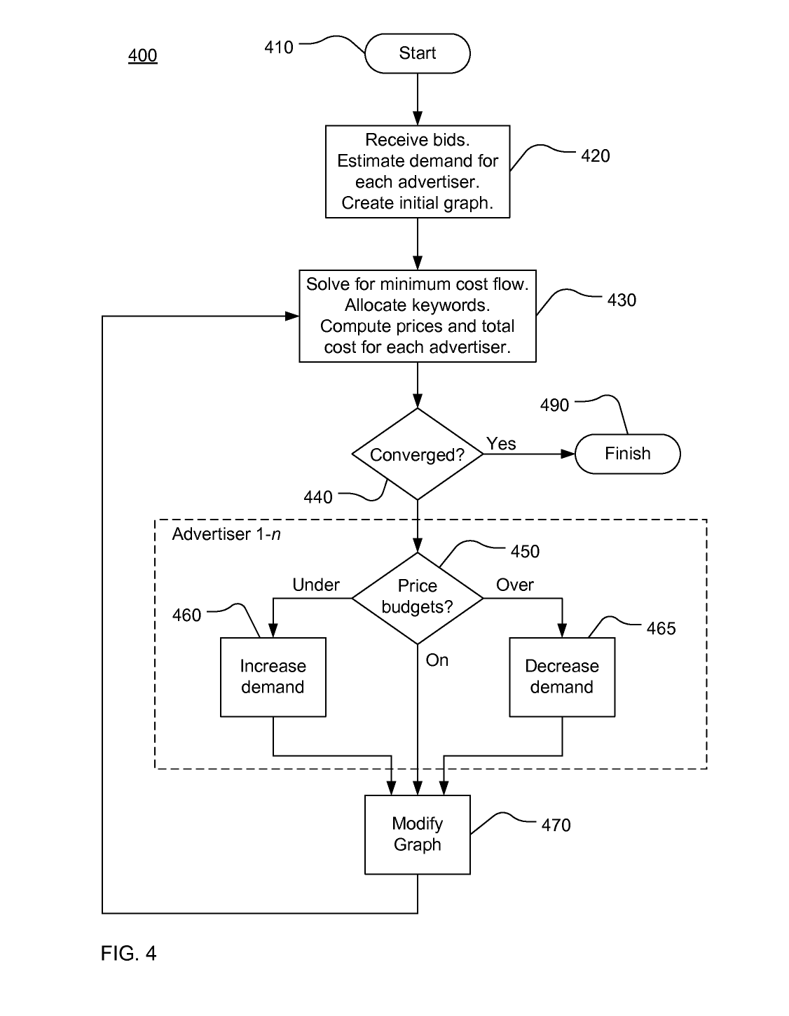

FIG. 4 is a flow chart of a process 400 for auctioning a set of keywords. Prior to, or coincident with, the start of the process 400 at 410, a set of keywords may be identified and made available to advertisers. At 420 bids may be received from a plurality of advertisers. Each bid may include a value of a click-through and a budget expressed as a total price which the advertiser does not intend to exceed. Also at 420, a flow graph relating the set of keywords and the bids received from the plurality of advertisers may be created. The flow graph may be the flow graph 200 or the flow graph 300 or another flow graph. In order to create the initial flow graph at 430, an initial value for the demand, in number of click-throughs, may estimated for each advertiser. The initial demand of each advertiser may be estimated to be the total number of anticipated occurrences of all keywords, or some other estimate.

A minimum cost flow solution for the flow graph may be computed at 430 using known methods for solving cost flow problems. Prices may be assigned to the click-throughs to each advertiser as previous described and the total price to each advertiser may be calculated.

At 440, a determination may be made if the keyword auction process has converged. In this context, the auction may be considered as converged if no advertiser's cost is over their respective budget and either all of the occurrences of the keywords have been allocated or all of the advertiser's budgets have been consumed. To limit the number of iterations, the keyword auction process may be considered converged if only a predetermined small fraction of the occurrences of the keywords, or the advertiser's budgets, or both are unallocated. If a determination is made at 440 that the process 400 is converged, the process may conclude at 490.

If a determination is made at 440 that the process has not converged, the demands, in number of click-throughs, for each advertiser may be adjusted. The calculated total price and the price budget for each advertiser may be considered in sequence at 450. At 460, the demand, in number of click-throughs, may be increased for each advertiser where the calculated total price is less than the available price budget. At 465, the demand, in number of click-throughs, may be decreased for each advertiser where the calculated total price exceeds the available price budget.

The flow graph may be revised at 470 and the process may continue at 430. The process sequence from 430-470 may be repeated iteratively until converged.

Description of Apparatus

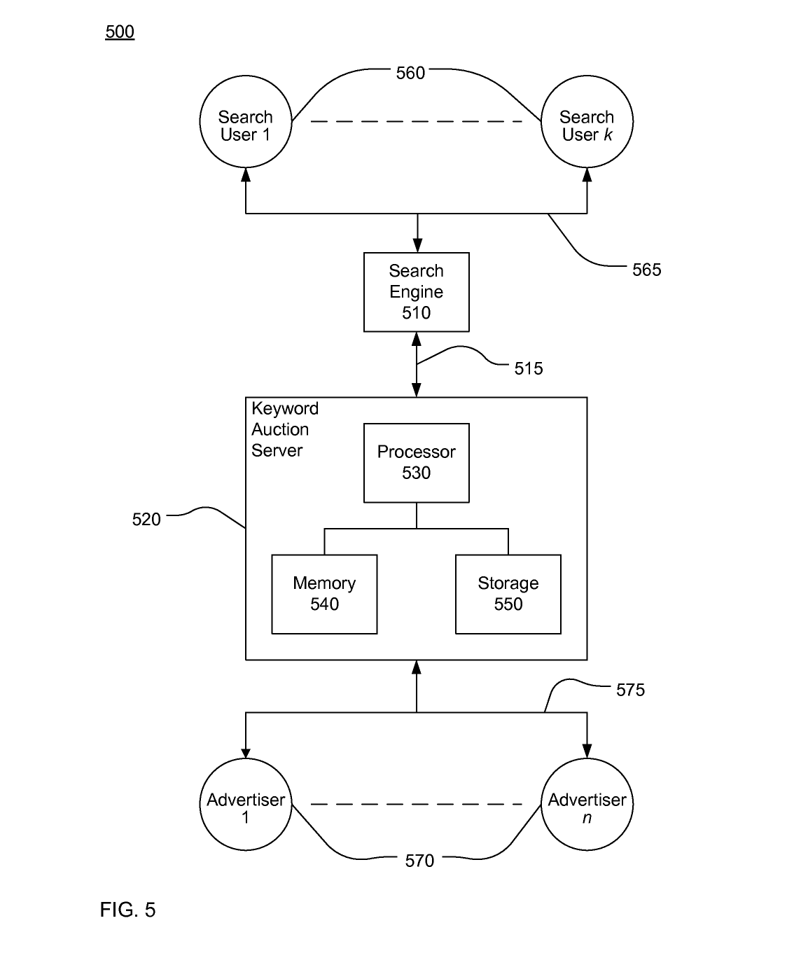

FIG. 5 is a block diagram of a system for conducting online searches. A plurality of search users 560 may be connected to search engine 510 by means of a network 565. Each search user 560 may be a network capable computing device, including but not limited to personal computers, server computers, computing tablets, set top boxes, video game systems, personal video recorders, telephones, personal digital assistants (PDAs), portable computers, and laptop computers. These computing devices may run an application program, such as a Web browser, and an operating system, including, for example, variations of the Linux, Unix, MS-DOS, Microsoft Windows, Palm OS, Solaris, Symbian, and Apple Mac OS X operating systems.

The network 565 may be the Internet, or may be another network such as a local area network, wide area network, storage area network, or other network.

The search engine 510 may be at least one server computer or other computing device, and may be a large plurality of server computers. The search engine 510 may include hardware and software adapted to receive search inquiries from the plurality of search users 560 and to respond to the search inquires by retrieving information relative to each inquiry. The search inquires may include search keywords provided by the search users. The search inquires may be in plain language form and may be parsed by the search engine to identify search keywords.

The search engine 510 may interact with a keyword auction server 520. The keyword auction server 520 may be integral with the search engine 510 or may be interconnected with the search engine 510 by a link 515. The link 515 may be a direct connection, or may be a network connection.

The keyword auction server 520 may be a server computer or any other computing device including software and/or hardware for providing functionality and features described herein. The processes, functionality and features may be embodied in whole or in part in software which operates on the keyword auction server 520 and may be in the form of firmware, an application program, an applet (e.g., a Java applet), a browser plug-in, a COM object, a dynamic linked library (DLL), a script, one or more subroutines, or an operating system component or service.

The keyword auction server 520 may include a processor 530, memory 540 coupled to the processor, and storage device 550 coupled to the processor and or memory. The keyword auction server 520 may include other specialized circuits and devices as necessary to provide the functionality and features described herein.

The storage device 550 may be any device that allows for reading and/or writing to a storage medium. Storage devices include, hard disk drives, CD and DVD drives, flash memory devices, and others. The storage device may include a storage media such as, for example, magnetic media such as hard disks, floppy disks and tape; optical media such as compact disks (CD-ROM and CD-RW) and digital versatile disks (DVD and DVD+RW); flash memory cards; and other storage media. The storage medium may store computer readable instructions that, when executed, cause the keyword auction server 520 to perform the processes described herein.

The keyword auction server 520 may be connected to a plurality of advertisers by a network 575. Each of the advertisers may access the network by means of any network capable devices 570 as previously defined. The network 575 may be the Internet, or may be another network such as a local area network, wide area network, storage area network, or other network.

Closing Comments

The foregoing is merely illustrative and not limiting, having been presented by way of example only. Although examples have been shown and described, it will be apparent to those having ordinary skill in the art that changes, modifications, and/or alterations may be made.

Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

For means-plus-function limitations recited in the claims, the means are not intended to be limited to the means disclosed herein for performing the recited function, but are intended to cover in scope any means, known now or later developed, for performing the recited function.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. A method for auctioning a set of keywords, the method comprising:
receiving bids from a plurality of advertisers
creating a flow graph that relates the set of keywords to the bids received from the plurality of advertisers
determining a minimum cost flow solution for the flow graph
allocating the keywords to the advertisers based on the minimum cost flow solution.

2. The method for auctioning a set of keywords of claim 1, further comprising calculating the price of a click-through for each of the plurality of advertisers based on the minimum cost flow solution.

3. The method for auctioning a set of keywords of claim 2, wherein the price of a click-through for each of the plurality of advertisers is calculated using the Vickrey-Clarke-Groves pricing method.

4. The method for auctioning a set of keywords of claim 1, wherein the bid received from each advertiser includes a value of a click-through and a demand expressed as a maximum number of click-throughs.

5. The method for auctioning a set of keywords of claim 4, wherein creating a flow graph further comprises
constructing a single source node
constructing n advertiser nodes, each advertiser node representing a corresponding one of the plurality of advertisers
constructing m keyword nodes, each keyword node representing a corresponding one of the set of keywords
constructing a single target node
constructing n edges e(s,i), i=1, 2, . . . n, wherein
edge e(s,i) connects the source node to the node representing advertiser i
edge e(s,i) has a capacity of dᵢ, a unit cost of 0 and a scaling factor of 1, wherein dᵢ is the demand included in the bid received from advertiser i
constructing m edges e(1,t)-e(m,t), wherein
edge e(j,t) connects the keyword node representing keyword j to the target node
edge e(j,t) has a capacity of aᵢ, a unit cost of 0 and a scaling factor of 1, wherein aᵢ is a number of appearances of keyword j
constructing n×m edges e(1,1)-e(n,m), wherein
edge e(i,j) connects the advertiser node representing advertiser i to the keyword node representing keyword j
edge e(i,j) has a capacity of ∞, a unit cost of −vᵢ, and a scaling factor of 1/pᵢⱼ, wherein vᵢ is the value included in the bid received from advertiser i and pᵢⱼ is a click-through probability for advertiser i and keyword j.

6. The method for auctioning a set of keywords of claim 4, wherein creating a flow graph further comprises
constructing a single source node
constructing n advertiser nodes, each advertiser node representing a corresponding one of the plurality of advertisers
constructing m keyword nodes, each keyword node representing a corresponding one of the set of keywords
constructing a single target node
constructing n edges e(i,t), i=1, 2, . . . n, wherein
edge e(i,t) connects the node representing advertiser i to the target node
edge e(i,t) has a capacity of dᵢ, a unit cost of 0, and a scaling factor of 1, wherein dᵢ is the demand included in the bid received from advertiser i
constructing m edges e(s,j), j=1, 2, . . . m, wherein
edge e(s,j) connects the source node to keyword node representing keyword j
edge e(s,j) has a capacity of aᵢ, a unit cost of 0, and a scaling factor of 1, wherein aᵢ is a number of appearances of keyword j
constructing n×m edges e(1,1)-e(n,m), wherein
edge e(i,j) connects the advertiser node representing advertiser i to the keyword node representing keyword j
edge e(i,j) has a capacity of ∞, a unit cost of −(vᵢ)(pᵢⱼ), and a scaling factor of pᵢⱼ, wherein vᵢ is the value included in the bid received from advertiser i and pᵢⱼ is a click-through probability for advertiser i and keyword j.

7. The method for auctioning a set of keywords of claim 1, wherein allocating the keywords to the advertisers further comprises allocating the keywords according to a probability distribution.

8. The method for auctioning a set of keywords of claim 7, wherein the probability that an instance of keyword j will be allocated to advertiser I is given by
$$\frac{g ( i , j )}{g ( j , t ) {p}_{ij}}$$
wherein g(i,j) is a flow for edge e(i,j) as defined by the minimum cost flow solution, g(j,t) is a flow along edge e(j,t) as defined by the minimum cost flow solution, and pᵢⱼ is a click-through probability for advertiser i and keyword j.

9. The method for auctioning a set of keywords of claim 2, wherein the bid received from each of the plurality of advertisers includes a value of a click-through and a budget expressed as a total cost, the method further comprising:
estimating a demand expressed as a number of click-throughs for each of the plurality of advertisers prior to creating the flow graph
calculating a total cost for each of the plurality of advertisers based on the allocation of the keywords and the calculated price of a click-through
comparing the total cost for each of the plurality of advertisers with the budget bid by the advertiser
reducing the estimated demand for any advertiser having a total cost in excess of the budget bid by the advertiser
if the estimated demand is reduced for one or more of the plurality of advertisers
revising the flow graph
repeating the method from determining a minimum cost flow solution for the flow graph.

10. A computing device to auction keywords, the computing device comprising:
a processor
a memory coupled with the processor
a storage medium having instructions stored thereon which when executed cause the computing device to perform actions comprising
receiving bids from a plurality of advertisers
creating a flow graph that relates the set of keywords to the bids received from the plurality of advertisers
determining a minimum cost flow solution for the flow graph
allocating the keywords to the advertisers based on the minimum cost flow solution.

11. The computing device to auction keywords of claim 10, the actions performed further comprising calculating the price of a click-through for each of the plurality of advertisers based on the minimum cost flow solution.

12. The computing device to auction keywords of claim 11, wherein the price the price of a click-through for each of the plurality of advertisers is calculated using the Vickrey-Clarke-Groves pricing method.

13. The computing device to auction keywords of claim 10, wherein the bid received from each advertiser includes a value of a click-through and a demand expressed as a maximum number of click-throughs.

14. The computing device to auction keywords of claim 13, wherein creating a flow graph further comprises
constructing a single source node
constructing n advertiser nodes, each advertiser node representing a corresponding one of the plurality of advertisers
constructing m keyword nodes, each keyword node representing a corresponding one of the set of keywords
constructing a single target node
constructing n edges e(s,i), i=1, 2, . . . n, wherein
edge e(s,i) connects the source node to the node representing advertiser i
edge e(s,i) has a capacity of dᵢ, a unit cost of 0, and a scaling factor of 1, wherein dᵢ is the demand included in the bid received from advertiser i
constructing m edges e(1,t)-e(m,t), wherein
edge e(j,t) connects the keyword node representing keyword j to the target node
edge e(j,t) has a capacity of aᵢ, a unit cost of 0, and a scaling factor of 1, wherein aᵢ is a number of appearances of keyword j
constructing n×m edges e(1,1)-e(n,m), wherein
edge e(i,j) connects the advertiser node representing advertiser i to the keyword node representing keyword j
edge e(i,j) has a capacity of ∞, a unit cost of −vᵢ, and a scaling factor of 1/pᵢⱼ, wherein vᵢ is the value included in the bid received from advertiser i and pᵢⱼ is a click-through probability for advertiser i and keyword j.

15. The computing device to auction keywords of claim 13, wherein creating a flow graph further comprises
constructing a single source node
constructing n advertiser nodes, each advertiser node representing a corresponding one of the plurality of advertisers
constructing m keyword nodes, each keyword node representing a corresponding one of the set of keywords
constructing a single target node
constructing n edges e(i,t), i=1, 2, . . . n, wherein
edge e(i,t) connects the node representing advertiser i to the target node
edge e(i,t) has a capacity of dᵢ, a unit cost of 0, and a scaling factor of 1, wherein dᵢ is the demand included in the bid received from advertiser i
constructing m edges e(s,j), j=1, 2, . . . m, wherein
edge e(s,j) connects the source node to keyword node representing keyword j
edge e(s,j) has a capacity of aᵢ, a unit cost of 0, and a scaling factor of 1, wherein aᵢ is a number of appearances of keyword j
constructing n×m edges e(1,1)-e(n,m), wherein
edge e(i,j) connects the advertiser node representing advertiser i to the keyword node representing keyword j
edge e(i,j) has a capacity of ∞, a unit cost of −(vᵢ)(pᵢⱼ), and a scaling factor of pᵢⱼ, wherein vᵢ is the value included in the bid received from advertiser i and pᵢⱼ is a click-through probability for advertiser i and keyword j.

16. The computing device to auction keywords of claim 10, wherein allocating the keywords to the advertisers further comprises allocating the keywords according to a probability distribution.

17. The computing device to auction keywords of claim 16, wherein the probability that an instance of keyword j will be allocated to advertiser I is given by
$$\frac{g ( i , j )}{g ( j , t ) {p}_{ij}}$$
where g(i,j) is the flow for edge e(i,j) as defined by the minimum cost flow solution, and g(j,t) is the flow along edge e(j,t) as defined by the minimum cost flow solution.

18. A storage medium having instructions stored thereon which when executed by a processor will cause the processor to perform actions comprising:
receiving bids from a plurality of advertisers
creating a flow graph that relates the set of keywords to the bids received from the plurality of advertisers
determining a minimum cost flow solution for the flow graph
allocating the keywords to the advertisers based on the minimum cost flow solution.

19. The storage medium having instructions stored thereon of claim 18, the actions performed further comprising calculating the price of a click-through for each of the plurality of advertisers based on the minimum cost flow solution.

20. The storage medium having instructions stored thereon of claim 19, wherein the price of a click-through for each of the plurality of advertisers is calculated using the Vickrey-Clarke-Groves pricing method.

21. The storage medium having instructions stored thereon of claim 18, where the bid received from each advertiser includes a value of a click-through and a budget expressed as a maximum number of click-throughs.

22. The storage medium having instructions stored thereon of claim 21, wherein creating a flow graph further comprises
constructing a single source node
constructing n advertiser nodes, each advertiser node representing a corresponding one of the plurality of advertisers
constructing m keyword nodes, each keyword node representing a corresponding one of the set of keywords
constructing a single target node
constructing n edges e(s,i), i=1, 2, . . . n, wherein
edge e(s,i) connects the source node to the node representing advertiser i
edge e(s,i) has a capacity of dᵢ, a unit cost of 0 and a scaling factor of 1, wherein dᵢ is the demand included in the bid received from advertiser i
constructing m edges e(1,t)-e(m,t), wherein
edge e(j,t) connects the keyword node representing keyword j to the target node
edge e(j,t) has a capacity of aᵢ, a unit cost of 0 and a scaling factor of 1, wherein aᵢ is a number of appearances of keyword j
constructing n×m edges e(1,1)-e(n,m), wherein
edge e(i,j) connects the advertiser node representing advertiser i to the keyword node representing keyword j
edge e(i,j) has a capacity of ∞, a unit cost of −vᵢ, and a scaling factor of 1/pᵢⱼ, wherein vᵢ is the value included in the bid received from advertiser i and pᵢⱼ is a click-through probability for advertiser i and keyword j.

23. The storage medium having instructions stored thereon of claim 21, wherein creating a flow graph further comprises
constructing a single source node
constructing n advertiser nodes, each advertiser node representing a corresponding one of the plurality of advertisers
constructing m keyword nodes, each keyword node representing a corresponding one of the set of keywords
constructing a single target node
constructing n edges e(i,t), i=1, 2, . . . n, wherein
edge e(i,t) connects the node representing advertiser i to the target node
edge e(i,t) has a capacity of dᵢ, a unit cost of 0, and a scaling factor of 1, wherein bᵢ is the demand included in the bid received from advertiser i
constructing m edges e(s,j), j=1, 2, . . . m, wherein
edge e(s,j) connects the source node to keyword node representing keyword j
edge e(s,j) has a capacity of aᵢ, a unit cost of 0, and a scaling factor of 1, wherein aᵢ is a number of appearances of keyword j
constructing n×m edges e(1,1)-e(n,m), wherein
edge e(i,j) connects the advertiser node representing advertiser i to the keyword node representing keyword j
edge e(i,j) has a capacity of ∞, a unit cost of −(vᵢ)(pᵢⱼ), and a scaling factor of pᵢⱼ, wherein vᵢ is the value included in the bid received from advertiser i and pᵢⱼ is a click-through probability for advertiser i and keyword j.

24. The storage medium having instructions stored thereon of claim 18, wherein allocating the keywords to the advertisers further comprises allocating the keywords according to a probability distribution.

25. The storage medium having instructions stored thereon of claim 24, wherein the probability that an instance of keyword j will be allocated to advertiser I is given by
$$\frac{g ( i , j )}{g ( j , t ) {p}_{ij}}$$
where g(i,j) is the flow for edge e(i,j) as defined by the minimum cost flow solution, and g(j,t) is the flow along edge e(j,t) as defined by the minimum cost flow solution.

26. A system for performing searches, comprising
a search engine
an keyword auction server coupled to the search engine, the keyword auction server performing actions comprising
receiving bids from a plurality of advertisers
creating a flow graph that relates the set of keywords to the bids received from the plurality of advertisers
determining a minimum cost flow solution for the flow graph
allocating the keywords to the advertisers based on the minimum cost flow solution.

27. The system for performing searches of claim 26, the actions performed further comprising calculating the price of a click-through for each of the plurality of advertisers based on the minimum cost flow solution.

28. The system for performing searches of claim 27, wherein the price of a click-through for each of the plurality of advertisers is calculated using the Vickrey-Clarke-Groves pricing method.

29. The system for performing searches of claim 26, wherein the bid received from each advertiser includes a value of a click-through and a budget expressed as a maximum number of click-throughs

30. The system for performing searches of claim 29, wherein creating a flow graph further comprises
constructing a single source node
constructing n advertiser nodes, each advertiser node representing a corresponding one of the plurality of advertisers
constructing m keyword nodes, each keyword node representing a corresponding one of the set of keywords
constructing a single target node
constructing n edges e(s,i), i=1, 2, . . . n, wherein
edge e(s,i) connects the source node to the node representing advertiser i
edge e(s,i) has a capacity of dᵢ, a unit cost of 0 and a scaling factor of 1, wherein dᵢ is the demand included in the bid received from advertiser i
constructing m edges e(1,t)-e(m,t), wherein
edge e(j,t) connects the keyword node representing keyword j to the target node
edge e(j,t) has a capacity of aᵢ, a unit cost of 0 and a scaling factor of 1, wherein aᵢ is a number of appearances of keyword j
constructing n×m edges e(1,1)-e(n,m), wherein
edge e(i,j) connects the advertiser node representing advertiser i to the keyword node representing keyword j
edge e(i,j) has a capacity of ∞, a unit cost of −vᵢ, and a scaling factor of 1/pᵢⱼ, wherein vᵢ is the value included in the bid received from advertiser i and pᵢⱼ is a click-through probability for advertiser i and keyword j.

31. The system for performing searches of claim 29, wherein creating a flow graph further comprises
constructing a single source node
constructing n advertiser nodes, each advertiser node representing a corresponding one of the plurality of advertisers
constructing m keyword nodes, each keyword node representing a corresponding one of the set of keywords
constructing a single target node
constructing n edges e(i,t), i=1, 2, . . . n, wherein
edge e(i,t) connects the node representing advertiser i to the target node
edge e(i,t) has a capacity of bᵢ, a unit cost of 0, and a scaling factor of 1, wherein bᵢ is the demand included in the bid received from advertiser i
constructing m edges e(s,j), j=1, 2, . . . m, wherein
edge e(s,j) connects the source node to keyword node representing keyword j
edge e(s,j) has a capacity of aᵢ, a unit cost of 0, and a scaling factor of 1, wherein aᵢ is a number of appearances of keyword j
constructing n×m edges e(1,1)-e(n,m), wherein
edge e(i,j) connects the advertiser node representing advertiser i to the keyword node representing keyword j
edge e(i,j) has a capacity of ∞, a unit cost of −(vᵢ)(pᵢⱼ), and a scaling factor of pᵢⱼ, wherein vᵢ is the value included in the bid received from advertiser i and pᵢⱼ is a click-through probability for advertiser i and keyword j.

32. The system for performing searches of claim 26, wherein allocating the keywords to the advertisers further comprises allocating the keywords according to a probability distribution.

33. The system for performing searches of claim 32, wherein the probability that an instance of keyword j will be allocated to advertiser I is given by
$$\frac{g ( i , j )}{g ( j , t ) {p}_{ij}}$$
where g(i,j) is the flow for edge e(i,j) as defined by the minimum cost flow solution, and g(j,t) is the flow along edge e(j,t) as defined by the minimum cost flow solution.
